(19) United States
(12) Patent Application Publication
(10) Pub. No.: US 2007/0234347 A1
(43) Pub. Date: Oct. 4, 2007

(54) Apparatus and method to receive media processing component

(76) Inventors: Joseph Grecco, Saddle Brook, NJ (US); Michael Stanford, Dallas, TX (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/393,130

(22) Filed: Mar. 29, 2006

(51) Int. Cl. G06F 9/445

(52) U.S. Cl. 717/174

(57) ABSTRACT

In one embodiment, an apparatus includes a framework module to receive a transmitted and shared media processing component and to install the media processing component within the framework module. The apparatus further includes a receiving application agent, operatively coupled to the framework module, to receive a media stream and to process the media stream using the installed media processing component within the framework module.

### BACKGROUND

1. Technical Field

Embodiments of the present invention are related to the field of communications, and in particular, to communication devices.

2. Description of Related Art

In the current art, negotiation of media processing operations (e.g., agreed upon encode/decode operations for codecs) in a communications session may be limited by the capabilities of the endpoints that are common to all parties. In other words, for a communications session to be established between the two parties, they may negotiate and agree on a common media processing operation, but that operation must exist at both endpoints prior to the negotiation. In some cases, this may result in sub-optimal quality of service for one or more of the parties or may result in the communications not being possible.

### BRIEF DESCRIPTION OF THE DRAWINGS

FIG. 1 is a block diagram of a communication system according to some embodiments of the present invention.

FIG. 2 is a flow chart for the communication system of FIG. 1, according to some embodiments of the present invention.

FIG. 3 is a block diagram of a communication system, according to some embodiments of the present invention.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention.

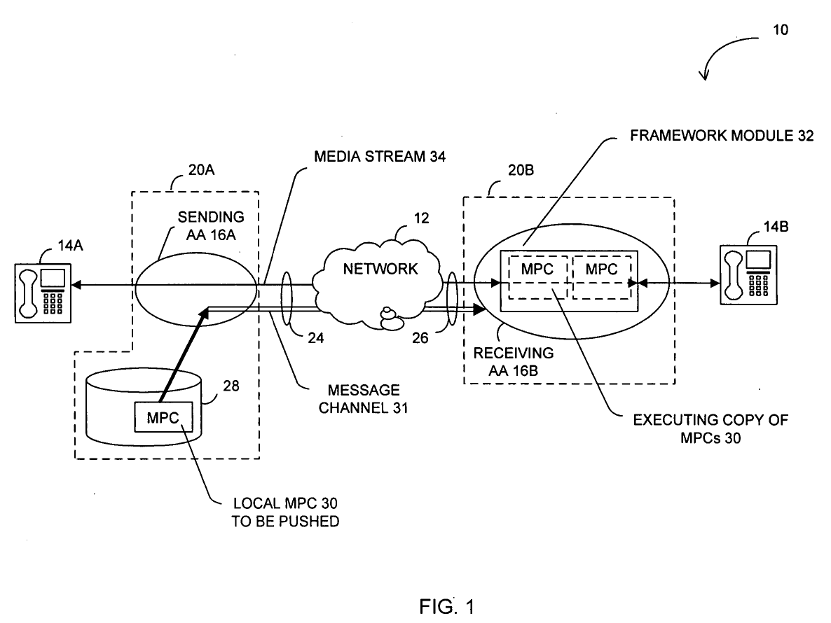

With reference to FIG. 1, there is illustrated a communication system 10, according to some embodiments of the present invention. The communication system 10 may utilize a media processing framework and protocol for negotiating, transporting and instantiating media processing components in the course of a mono or multi-media communications session. The following list presents exemplary definitions of various components of the communication system 10 which will be used hereinafter to describe the communication system 10.

Media Processing Component (MPC)—an executable, computer code implementation of a media-processing operation(s). The media-processing operation may be described as one that takes a stream of media data, such as digitized voice or video, and performs certain computations and/or translations on the data and outputs the resultant data. Examples of such media-processing operations may include operations used for audio/video codecs, audio gain control, or audio/video mixers. In some embodiments, the MPC may be self-identifying.

Media Processing Framework Module (Framework Module)—software that enables an application, such as an Application Agent defined below, to create, modify and/or control a collection of Media Processing Components.

Compute Device—hardware (e.g., CPU, memory etc.) that execute the Framework Module and Media Processing Components.

Application Agent (M)—one or more software application(s) executing on a Compute Device and controlling MPC(s) through the Framework Module. An AA may represent a participant in a multimedia session. One example of many possible examples of an AA may be a personal voice mail that physically runs on a cell phone. In some embodiments, the AA may consist of multiple application programs (e.g., may be a distributed program)

Network Interface Controller (NIC)—hardware and software that enable communication between AAs.

Media Processing Protocol—set of rules defined herein for the negotiation, transport, and instantiation of Media Processing Components in a mono or multi-media communications session.

Referring to FIG. 1, in the communication system 10, according to some embodiments of the present invention, there may be an N-way communications session wherein two or more parties transmit media data between each other over a network 12. In some embodiments, the network 12 may be a packet-switched network, such as an internet protocol (IP) network. In some embodiments, the network 12 may be the internet. In some embodiments, the media data may include audio, video, and/or other digital data.

For the purposes of simplification, in FIG. 1 the communication system 10 may be illustrated with a single sending party and a single receiving party. The sending party may be shown as having an input/output device 14A configured as an input device and a receiving party may be shown as having an input/output device 14B configured as an output device. Solely for the purposes of illustration, the input/output devices 14A and 14B are illustrated in FIG. 1 as digital telephones. However, the input/output devices 14A and 14B may include many other types of devices for generating and/or receiving media data. For example, in some embodiments, the input/output devices 14A and 14B may be used for video conferencing. In some embodiments, the input/output devices 14A and 14B may be soft phones (soft clients), like Skype™, Netmeeting™ or Microsoft Messenger™, or a robotic agent, such as computerized integrated voice response (IVR).

AAs 16A and 16B may be coupled to the input/output devices 14A and 14B, respectively, with the AA 16A being configured to be a sending AA and the AA 16B being configured to be a receiving (target) AA in FIG. 1. The AAs 16A and 16B may be executed in Compute Devices 20A and 20B, respectively. In some embodiments, the Compute Devices 20A and 20B may each comprise a host computer with a NIC (not shown) for coupling the Compute Devices 20A and 20B via communication links 24 and 26, respectively, to the network 12. In some embodiments, the communication links 24 and 26 may each be coupled to a packetizing unit (not shown) of the network 12, such as a gateway, for packetizing and depacketizing the data, with the data traveling in packets through the network 12. In some embodiments, the Compute Devices 20A may be a handheld device, like a cell phone or bluetooth device and the communication links 24 and 26 may be wireless communication links. In some embodiments, the Compute Devices 20A and 20B may be media gateways; hence, the Compute Devices 20A and 20B may be coupled directly to the network 12 without the use of communication links 24 and 26. In some embodiments, the functions of Compute Devices 20A and 20B may be a distributed in distributed computing systems, in which case the Compute Devices 20A and 20B each may be considered a single entity logically which executes the Framework Module and the MPC.

As previously described, the AAs 16A and 16B may each represent a party in an N-way communications session over the network 12. On the sender's side in the input device 14A, the media data stream may be digitized and typically encoded/compressed before transmission over the network 12. The data then may be decoded/uncompressed on the receiver's side in the output device 14B where it then may be appropriately rendered, such as out of a speaker or a video screen. There are many techniques or operations for encoding and decoding audio and video data. The different encoding/decoding techniques may exhibit different characteristics with regard to compression, fidelity loss, and processing load. In order for a communications session to be established between the two parties, they may negotiate and agree on a common encode/decode techniques to use. Further, there may be additional processing performed on the media data stream in the input/output devices 14A and 14B to realize the quality desired by the user. One or more of these media processing techniques are incorporated into the self-identifying MPCs defined above.

In some embodiments, the components of the Compute Devices 20A and 20B may be the same; hence, the same reference numbers will be used for the same components and not all components will be shown for both of the Compute Devices 20A and 20B. Likewise, in some embodiments, the AAs 16A and 16B may have the same functionality, e.g. having both the sending and receiving functionalities described herein. With the configuration shown in FIG. 1, at least the Compute Device 20A may have a local storage 28 for storing one or more MPC(s) 30. The MPC(s) 30 may be available to be pushed (uploaded) by the sending AA 16A over a message channel 31 to the receiving AA 16B. This uploading of the MPC(s) 30 presupposes that the receiving AA 16B is enabled to receive the MPC(s) 30 (has MPC sharing capability), as may be determined in a negotiation process to be described hereinafter. Additionally, this presupposes that the AA 16A has been selected in the negotiation process to be the “sending AA”, which is the AA to transmit (upload) the MPC(s) 30 to the receiving AA 16B. In some embodiments, the message channel 31 may be over the communication links 24 and 26.

Referring to FIG. 1, the Compute Device 20B may have stored therein and may execute the AA 16B and a Framework Module 32 in which a transmitted and uploaded MPCs 30 may be installed. The Framework Module 32 may provide the framework for the AA 16B to install the MPCs 30 and to interface with the installed MPCs 30. In some embodiments, the Framework Module 32 may be standalone software that implements part of a runtime environment in which the AA runs. Similar to an operating system, the AA 16B may use the services of the Framework Module 32 to implement an environment in which the MPCs 30 may be executed. Hence, the AA 16B uses resources which may include the MPCs 30, which may be temporally installed on the Compute Device 20B. In other words, the AA 16B is the client that provides the controlling logic and drives and controls the Framework Module 32 and the MPCs 30.

The Framework Module 32 is shown in FIG. 1 as having two transmitted (uploaded) MPCs 30 installed therein that where pushed from the sending AA 16A. The uploaded MPCs 30 may be executing copies (images) of the MPCs 30 contained in the local storage 28 at the sending AA 16A. In other embodiments, the MPCs 30 in the Framework 32 may be obtained from different AAs.

Upon the MPCs 30 being installed in the Framework Module 32, the MPCs 30 may be executed by the Compute Device 20B to process a media stream 34 from the sending AA 16A. In some embodiments, the media steam 34 may be transmitted over the communication links 24 and 26 to and from the network 12.

In FIG. 1 the Media Processing Protocol, according to some embodiments of the present invention, is a session protocol which may allow the sending AA 16A to share or loan its MPCs 30 with the receiving AA 16B. However, the sending AA 16A may or may not be the AA starting or initiating the session protocol. In other words, in some embodiments, the sending AA, which uploads the MPC(s) 30, may also initiate the session protocol. In some embodiments, the MPC 30 may come from any AA; hence, the receiving AA 16B, the one installing the uploaded MPC(s) 30, also may start or initiate the session protocol. Hence, the terms “sending AA” and “receiving M” may refer to the uploading of the MPC(s) 30; whereas the terms “contacting AA” (the initiating AA) and “contacted AA” may refer to the initial contact between AAs in the session protocol.

In some embodiments, the MPCs used by the N Application Agents 16 (N=2 in the example of FIG. 1) in an N-way communications session may come from just one of the N Compute Devices 20. In other embodiments, the MPCs 30, where there are more than one MPC shared, may come from more than one Compute Device 20, e.g., those Compute Devices 20 having the most updated MPCs of each type may contribute their MPCs for use by the N Application Agents 16. In general, the AAs of the communication system 10 may distribute MPCs 30 among the N Compute Devices 20 based upon a number of schemes designed to increase the chance of achieving higher levels of performance, quality, and interoperability. Hence, the communication system 10, according to some embodiments of the present invention, is not limited by the pre-existing capabilities of the endpoints that are common to all parties prior to the communication session.

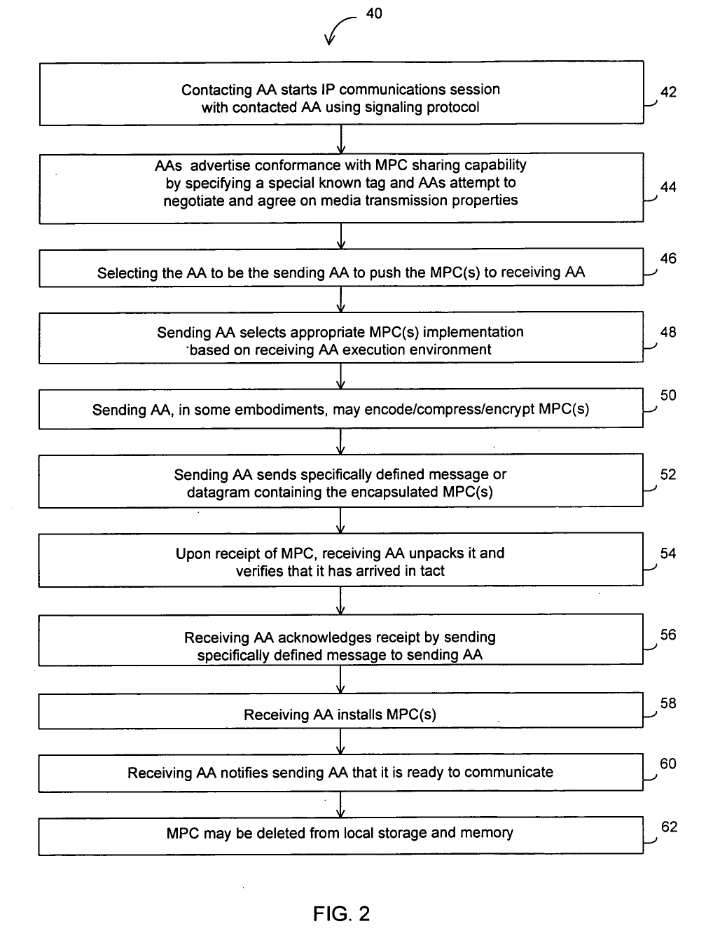

Referring to a flow chart of FIG. 2, there is illustrated an N-way IP communications session 40 for the communication system 10 of FIG. 1 utilizing the Media Processing Protocol, according to some embodiments of the present invention. A first stage of the interaction between a contacting AA and a contacted AA may be described as discovery and negotiation. In an operation 42, one AA (the contacting AA) may initiate an IP communications session with another AA (the contacted AA) using a signaling protocol, such as Session Initiation Protocol (SIP) defined by Internet Engineering Task Force (IETF) RFC 2543, at http://www.ieff.org. SIP may include a plurality of functions that establish, modify, and terminate multimedia sessions, including the ability to have multiple SIP connections in a single Transmission Control Protocol (TCP)/IP session. However, there are other such protocols available for performing these functions and SIP is merely illustrative of one such protocol. When SIP is used, the network 12 may be a packet-switched IP network.

In an operation 44, there is a negotiation phase where the 2 parties (two AAs) attempt to negotiate and agree on media transmission properties (e.g., encode/decode MPCs, bandwidth parameters, etc). In some embodiments, this negotiation may be undertaken during the session establishment phase. In other embodiments, this negotiation may be undertaken after a session has been established, perhaps because of network congestion conditions.

In the operation 44, the AAs advertise their conformance with the previously described MPC sharing capability by specifying a “special” known tag in their list of acceptable media. As an example, using the SIP protocol, an AA advertises the media types and acceptable formats in a structure known as the Session Description Protocol (SDP). An AA that implements the MPC sharing capability may specify that they support pushable MPCs by specifying the special known tag in its list of supported media types. In the following example, the SDP may be used to indicate the AA will accept audio in International Telecommunication Union (ITU)-T Recommendation G.711 plaw (operations for uncompressed codecs available for packet-based networks, at http://www.itu.int) as indicated by the media type 0 in the m=line. It further may specify that it conforms to the MPC sharing capability by providing a dynamic payload type 200 and indicating that 200 maps to PUSHABLE. Here the tag PUSHABLE is being used as the special known identifier for the MPC sharing capability.

### EXAMPLE 1

v=0

o=jgrecco 2890844526 2890842807 IN IP4 192.168.1.1

s=SDP PushableCodec

m=audio 49170 RTP/AVP 0 200

a:rtpmap:200 PUSHABLE/INTC/PXA27x

As previously described, the N-way IP communications session 40 may enable one AA to push (i.e., upload) the implementation of MPCs to another AA in the course of the IP communications session. In the operation 44, to ensure that the MPC is executable on the Compute Device having the receiving AA, it is desirable that the receiving AA identify its execution environment. In the above SDP example, this information is passed in the rtpmap line (INTC/PXA27x). It may be advantageous to provide additional information in this way. For example, the version of the Framework Module may also be provided.

The next stage of the N-way IP communications session 40 may be generally referred to as the MPC push. Once it has been established that both AAs implement the MPC sharing capacity, the AAs may now exchange the MPC's that realize the desired media processing operations. Unless otherwise indicated during the negotiation operation 44, it is assumed that either AA in the communications session is capable of sending and receiving a MPC.

In an operation 46, one of the AAs may be selected for pushing the MPC(s) and becomes the sending AA. In some embodiment, the protocol defined by this N-way IP communications session 40 may specify that the contacting AA takes precedence over the contacted AA for sending MPCs, and thereby automatically selects the contacting AA to be the sending AA for pushing the MPC(s) and the contacted AA becomes the receiving AA. Alternatively, in the operation 46 the contacting AA may defer the MPC exchange to the contacted AA by sending it a specifically defined message.

If the contacting AA decides to send MPC(s) as the sending AA, it undertakes the following operations. In an operation 48, the sending AA may select the appropriate MPC(s) implementation based on the receiving AA execution environment. In an operation 50, in some embodiments, the sending AA may encode/compress/encrypt the MPC(s) for reliable, efficient and secure transport. In other embodiments, the operation 50 may be eliminated. In an operation 52, the sending AA may send a specifically defined message or datagram containing the encapsulated MCP(s) using an appropriate mechanism/protocol. For example, the MPC may be sent as the MIME encoded body of a SIP INFO message. If the contacting AA defers the MPC exchange to the contacted AA by sending it a specifically defined message in the operation 46u, then upon acknowledging that message, the contacted AA may perform the operations 48, 50 and 52 of the sending AA described above.

The next stage of the N-way IP communications session 40 may be referred to as a validation and acknowledgement stage. In an operation 54, upon receipt of the MPC, the receiving AA may unpack it and may verify that it has arrived intact. In an operation 56, the receiving AA may acknowledge the successful receipt by sending a specifically defined message to the sending AA.

The next stage of the N-way IP communications session 40 may be referred to as a MPC Installation and activation stage. Once all of the MPCs have been received, in an operation 58, the receiving AA may install them into its Framework Module using the framework and interfaces defined by the Framework Module and any knowledge it has for the purpose (function) of the MPC. In some embodiments, the MPCs may be self-describing, as will be discussed hereinafter. In some embodiments, it may be assumed that the receiving AAs have intimate knowledge of the function of a MPC and may use that knowledge when configuring the Framework Module and controlling the media streams therein. In other embodiments, there may be a base set of interfaces in the MPC and Framework Module to allow the receiving AAs to interact with them while having a minimal knowledge of their function. In some embodiments, as an example of how this may be implemented, the receiving AA may unpack the executable binary MPC, store it in a specifically defined folder in local storage. The AA then may load the executable image (e.g., “LoadLibrary”) of the MPC into mass memory and use Framework Module interfaces to instantiate instances of the MPC and “wire” them into a media stream graph.

With respect to the MPC 30 being self-identifying, in some embodiments, two mechanisms may be used. The MPC 30 may be encapsulated in a digital envelope for transmission from the sending AA 16A to the receiving AA 16B. Headers in the envelope may contain information describing the MPC 30, perhaps including digital signatures, unpacking instructions, interface information and like information. Once the MPC 30 is unpacked and loaded at the receiving AA 16B, it may have interfaces that would allow it to be identified at runtime as well.

The next stage of the N-way IP communications session 40 may be referred to as a MPCs usage stage. Once the MPCs have been successfully installed in the Framework Module, in an operation 60, the receiving AA then notifies the sending AA that it is ready to communicate. In some embodiments, this may be accomplished via existing mechanisms such as via realtime transfer protocol (RTP) or may be done via a message specifically defined for the purpose.

In some embodiments, the next stage of the N-way IP communications session 40 may be referred to as a clean-up. In other embodiments, this stage may be eliminated. It may be desirable for the MPCs to be actively deleted from the receiving AA after use or otherwise rendered unusable after use. In this event, in an operation 62, upon termination of the communication's session, the receiving AA may delete the MPCs from local storage and memory or disable the MPCs. In these embodiments, the receiving AA in effect may make certain assurances that the MPCs that have been uploaded will be deleted or disabled after the authorized use. In some embodiments, if the sending AA wants to loan the receiving AA a MPC for use during a session, the sending AA may specify that the MPC cannot be used by the receiving AA after the session has been completed.

In some embodiments, the MPC may be implemented as a dynamically linked library (DLL) or shared library (SL) using established operating system (OS) specific methods. The MPC may be up loaded as a compressed zip archive file. The Framework Module may receive the upload as a sequence of packets. Once the Framework Module has received the entire MPC archive, it may unpack it into a DLL or SL. Using OS specific established methods, it may “load” the DLL (or SL) into memory and enumerate its entry points (interface). At this point, the Framework Module is able to interoperate with the MPC (call its interface). Using the MPC's interfaces, the Framework module may exchange its own entry points to establish a two-way communications between Framework Module and the MPC. This may allow the MPC to use services provided by the Framework Module and may allow the Framework Module to control the MPC.

Examples of what might be some of the interfaces on a MPC include an interface for pushing in a media packet of the media stream for processing specific to that MPC. Another might be an interface allowing the MPC to present a media packet (perhaps after processing). In some embodiments, these interfaces may be considered “generic” and no understanding of the processing done by the MPC is needed by the Framework Module, on behalf of the AA, to use the MPC. Hence, the Framework Module may simply feed packets through the MPC with no need for knowing what is being done inside. In some embodiments, the MPCs may publish other interfaces that are specific to the operations the MPC perform. These interfaces may need a priori (or otherwise discovered) knowledge to use. For example, a gain control might have an interface specifically for setting the value of the gain up or down. A digit detector might have an interface for reporting digit events. Described above is one of many ways to accomplish these operations. Java, activeX, .NET have other ways of accomplishing these operations.

The N-way IP communications session 40, as described above, is an example of how the session 40 may be implemented using SIP/SDP. However, the session 40 may be implemented using other protocols. The network 12 of FIG. 1 may be any network that can be used for signaling (to negotiate) and data transfer (to push the MPC 30 image). The SIP example merely is an example using SIP over an IP network. The only network need is to have the ability to signal between the sending and receiving AAs 16A and 16B and to move the MPC 30. This may be undertaken by a number of network arrangements other than what has been shown, including even using IP to signal and push the MPC and then using an analog connection for the media stream 34 or undertaking all communications over a raw IP connection using proprietary protocols.

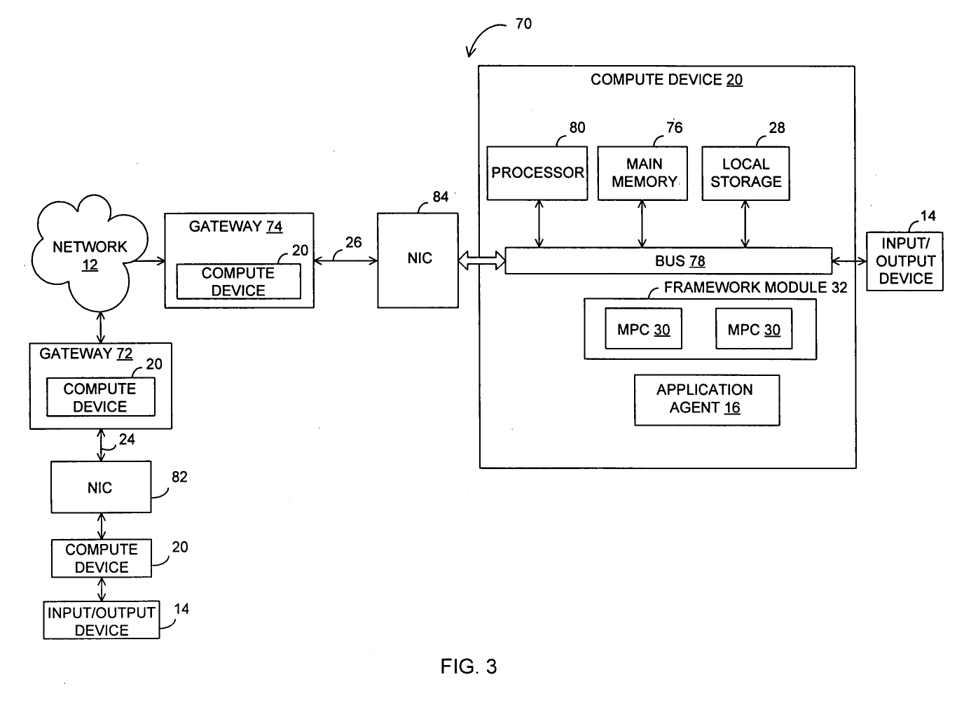

Referring to FIG. 3, there is shown a communication network 70, according to some embodiments of the present invention. The difference between this communication network 70 and the communication network 10 of FIG. 1 is that the Compute Device 20 of FIG. 1 also may be included in a pair of media gateways 72 and 74 coupled to the ends of communication links 24 and 26, respectively. Other aspects remain the same as in FIG. 1; hence, the same reference numbers are used. Those components previously described with respect to FIG. 1 will not be described again; however, one of the Compute Devices 20 is illustrated in more detail in FIG. 3. In addition to the previously described local storage 28, the Compute Device 20 may have a main memory 76. The local storage 28 and the main memory 76 may be coupled to a bus system 78. The application Agent 16 and the Framework Module 32 with the MPC 30 may be stored in the local storage 28 and moved to the main memory 76 for execution by a processor 80. NIC 82 and 84 may be coupled the Compute Devices 20 to the communication links 24 and 26, respectively. In some embodiments, the NIC 82 and 84 may be integrated into the Compute Devices 20.

Referring to FIG. 3, in some embodiments, as a result of sharing the MPCs among multiple AAs, the communication system 70 may have the ability to distribute the execution of the MPCs, which may allow for a more efficient load distribution over static distributions that do not use shared MPCs. This may be of particular value in communications such as conferences, where the MPCs typically have higher processor loads. For example, this may be undertaken where the MPC 30, for example, is used for encoding/decoding. In this embodiment, the network 70 may includes the Compute Device 20 in the media gateways 72 and 74 at the end of the communication links 24 and 26. The Compute Devices 20 connected to and associated with the input/output devices 14 may be referred to as “endpoint Compute Devices” and the Compute Devices 20 associated with or embedded in the gateways 72 and 74 may be referred to as “intermediate Compute Devices”. In some embodiments, all the Compute Devices 20 may have the same components, as illustrated by the detailed Compute Device 20 in FIG. 3.

As an illustrative example, assume that the media stream is being transmitted from the endpoint Compute Device 20 which is coupled to the gateway 72 by way of communication link 24. If this endpoint Compute Device 20 transmitting the media stream does not have the power to run the codec operation to encode the media stream, then the codec operation may run on the intermediate Compute Device 20 in the gateway 72 to encode at least a portion of the media stream. Likewise, if the endpoint Compute Device 20 coupled to the gateway 74 by the communication link 26 does not have the power to run the codec MPC in decoding the media steam, then the MPC may run on the intermediate Compute Device 20 in the gateway 74 to decode at least a portion of the media stream.

In summary, the arrangement of Compute Devices in the communication network 70 may take many different configurations. In some embodiments, uploading the MPC may only be to one or both of the intermediate Compute Devices 20 to help in sharing the computational tasks. In other embodiments, the MPC may only be uploaded to at least one endpoint Compute Devices 20 to allow both endpoints to share the same MPC. In some embodiments, the MPC may be distributed to one or more intermediate Compute Devices 20 and to one or more endpoint Compute Devices. In some embodiments, the computational tasks may be divided up between an endpoint Compute Device 20 and an intermediate Compute Device 20, e.g., encryption/decryption undertaken at the gateway 72 or 74 and encoding/decoding or codec undertaken at the sending or receiving AA. In general, with respect to the intermediate Compute Devices 20, the network 70, according to one embodiment of the present invention, may allow for the distribution of the processing to devices anywhere between the endpoints.

Examples of the main memory 76 include, but are not limited to, static random access memory (SRAM) and dynamic random access memory (DRAM). Examples of the local storage 28 include, but are not limited to, a hard disk drive, a compact disk drive (CD), a digital versatile disk driver (DVD), a floppy diskette, a tape system and so forth.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. An apparatus, comprising:
a framework module to receive at least one transmitted and shared media processing component and to install the at least one shared media processing component within the framework module; and
a receiving application agent, operatively coupled to the framework module, to receive a media stream and to process the media stream using the at least one shared media processing component installed within the framework module.

2. The apparatus according to claim 1, wherein the receiving application agent is adapted to provide an indication of being able to operate with the at least one shared media processing component prior to the framework module receiving the at least one shared media processing component.

3. The apparatus according to claim 2, wherein the receiving application agent is further adapted to provide an identification of an execution environment of the apparatus.

4. The apparatus according to claim 1, wherein the framework module is further adapted to delete or disable the at least one shared media processing component upon a completion of the processing of the media stream.

5. The apparatus according to claim 1, wherein the receiving application agent is further adapted to
verify that the at least one shared media processing component is intact upon receipt of the at least one shared media processing component by the framework module; and
send an acknowledgement message upon verifying that the at least one shared media processing component is intact.

6. The apparatus according to claim 1, wherein the receiving application agent is adapted to send a notification to a sending application agent that the receiving application agent is ready to communicate after the at least one shared media processing component has been installed in the framework module, the sending application agent being external to the apparatus.

7. The apparatus according to claim 1, wherein the receiving application agent is adapted to decode the media stream with the at least one shared media processing component.

8. The apparatus according to claim 1, wherein the at least one shared media processing component includes a self-identifying media processing component.

9. The apparatus according to claim 8, wherein the self-identifying media processing component includes at least one media processing operation.

10. The apparatus according to claim 1, further comprising:
a sending application agent to transmit another shared media processing component to another receiving application agent disposed on another apparatus.

11. The apparatus according to claim 10, wherein at least one of the sending or the other receiving application agent is adapted to determine that the sending application agent is to transmit the at least one shared media processing component.

12. The apparatus according to claim 10, wherein the sending application agent is adapted to initiate an inquiry as to whether the other receiving application agent is capable of receiving and operating with the at least one shared media processing component.

13. The apparatus according to claim 10, wherein the sending application agent is adapted to transmit the at least one shared media processing component to the other receiving application agent over a network.

14. A method comprising:
receiving at least one transmitted and shared media processing component by a framework module disposed on a compute device;
installing the at least one shared media processing component into the framework module;
receiving a media stream by a receiving application agent of the compute device; and
using the at least one shared media processing component by the receiving application agent to process the media stream.

15. The method according to claim 14, further comprising:
upon receipt of the at least one shared media processing component, verifying that the at least one shared media processing component is intact; and
upon verifying that the at least one shared media processing component is intact, sending an acknowledgement message.

16. The method according to claim 14, further comprising:
upon installing the at least one shared media processing component, sending a notification that the receiving application agent is ready to communicate.

17. The method according to claim 14, further comprising:
transmitting another or the same shared media processing component from a sending application agent disposed on the same compute device to another receiving application agent disposed on another compute device to enable the sending application agent to send the same or another media stream to the other receiving application agent of the other compute device.

18. The method according to claim 17, comprising:
prior to transmitting the other or the same shared media processing component, negotiating with the other receiving application agent by the sending application agent to determine whether the sending application agent is to transmit the other or the same shared media processing component.

19. The method according to claim 18, wherein the negotiating to determine the at least one shared media processing component includes the sending application agent receiving a contact inquiry from the other receiving application agent to initiate the negotiation.

20. The method according to claim 19, wherein the negotiating to determine the at least one shared media processing component further includes receiving by the sending application agent, a tag from the other receiving application agent in response to the contact inquiry, with the tag indicating that the other receiving application agent is capable of using the other or the same shared media processing component.

21. The method according to claim 20, wherein the negotiating to determine the at least one shared media processing component further includes receiving by the sending application agent, information concerning an execution environment of the other receiving application agent.

22. An article comprising a storage medium; and a plurality of instructions stored in the storage medium, the plurality of instructions implementing
a framework module to receive at least one transmitted and shared media processing component for an apparatus upon installation on the apparatus, and to install the at least one shared media processing component within the framework module; and
a receiving application agent operatively coupled to the framework module, and upon installation on the apparatus to receive a media stream for the apparatus and to process the media stream using the at least one shared media processing component installed within the framework module.

23. The article according to claim 22, wherein the receiving application agent is adapted to provide to an entity outside of the apparatus, an indication of being able to accept the at least one shared media processing component prior to receiving the at least one shared media processing component.

24. The article according to claim 23, wherein the receiving application agent is further adapted to provide to the entity outside of the apparatus, an identification of an execution environment of the apparatus, prior to receiving the at least one shared media processing component.

25. The article according to claim 22, wherein the at least one shared media processing component is received from a sending application agent disposed on another apparatus.

26. A system, comprising:
a receiving framework module to receive at least one transmitted and shared media processing component and to install the at least one shared media processing component within the receiving framework module;
a receiving application agent, operatively coupled to the receiving framework module, to receive a media stream and to process the media stream using the at least one shared media processing component; and
a mass storage to store the receiving application agent, the receiving framework module, and the at least one shared media processing component.

27. The system according to claim 26, further comprising:
a sending application agent, operatively coupled to the mass storage, to access the same or another shared media processing component to transmit the accessed shared media processing component to another receiving application agent to enable the other receiving application agent to receive and process another media stream to be send by the sending application agent.

28. The system according to claim 27, wherein the receiving application agent is adapted to transmit an indication to an entity outside the system, indicating the receiving application agent is able to operate with the at least one shared media processing component prior to receiving the at least one shared media processing component.

29. The system according to claim 27, wherein an intermediate computing device is either operationally coupled to the receiving application agent or an original sending application providing the media stream; the intermediate compute device includes an intermediate framework module to receive and install the at least one shared media processing component within the intermediate framework module; and an intermediate application agent, operatively coupled to the intermediate framework module, to receive and process the media stream using the at least one shared media processing component installed within the intermediate framework module.

30. The system according to claim 29, wherein the intermediate compute device is part of a media gateway.
